(19) United States
(12) Patent Application Publication
(10) Pub. No.: US 2025/0262958 A1
(43) Pub. Date: Aug. 21, 2025

(54) INTEGRATED ISOLATION SWITCH OPERATION FOR AC AND DC CHARGING

(71) Applicant: Ford Global Technologies, LLC, Dearborn, MI (US)

(72) Inventors: Haider Mhiesan, Dearborn, MI (US); Yuan Zhang, Canton, MI (US); Mohamed Elshaer, Canton, MI (US); Mark J. Ferrel, Brighton, MI (US)

(21) Appl. No.: 18/444,392

(22) Filed: Feb. 16, 2024

(51) Int. Cl. B60L 53/16; B60L 53/10; B60L 53/62; H02J 7/04

(52) U.S. Cl. CPC B60L 53/16; B60L 53/11; B60L 53/62; H02J 7/04; B60L 2210/10; B60L 2210/40

(57) ABSTRACT

A switch may be added to an AC charge path of an EV charge system. A controller may operate the switch and other switches. The controller may direct a traction battery to pre-charge a capacitor of an AC filter in the AC charge path before connecting the AC charge path between the traction battery and a power source. In embodiments including voltage sensing, the controller may track the power source voltage and command a voltage of the AC charge path to follow the power source voltage before connecting the AC charge path between the traction battery and the power source. After pre-charging, the controller may track the power source voltage and command the AC charge path connect between the traction battery and the power source at a zero-crossing of the voltage of power source.

### TECHNICAL FIELD

This disclosure relates to automotive battery charging systems.

### BACKGROUND

The North American Charging Standard (“NACS”) is being standardized as SAE J3400. To implement this standard within certain current vehicles, an on-board charger may need to be capable of withstanding 1000V DC potential when DC charging from an external power source.

### SUMMARY

A vehicle may include a charge port, a traction battery system including a traction battery and an isolating switch, a charging system including a DC charge path, connected between the charge port and isolating switch, including a DC enabling switch and a DC/DC charger and an AC charge path, connected between the charge port and isolating switch, including a DC/DC converter, a DC/AC inverter, an AC filter including a capacitor, and an AC enabling switch connected between the charge port and AC filter, and a controller programmed to, after the charge port is physically connected with a charge cord that is associated with a power source and before an electrical connection between the traction battery and power source is established, control at least some of the isolating, DC enabling, and AC enabling switches to permit pre-charging of the capacitor.

A method may include, responsive to data from at least one voltage sensor associated with an AC enabling switch of an AC charge path between a traction battery and charge port indicating a voltage across the AC enabling switch has remained unchanged after commanding the AC enabling switch to open while an isolating switch between the traction battery and AC charge path and a switch of a charge cord connected with the charge port remain closed, preclude DC charging of the traction battery with power supplied via the charge cord, and, responsive to the data indicating the voltage has reduced after the commanding, permit DC charging of the traction battery via a DC charge path that does not include the AC enabling switch.

An automotive charge system may include a DC charge path, connected between a charge port and an isolating switch of a traction battery system, including a DC enabling switch and a DC/DC charger, an AC charge path, connected between the charge port and isolating switch, including a DC/DC converter, a DC/AC inverter, an AC filter, an AC enabling switch connected between the AC filter and charge port, and a pair of voltage sensors connected such that the AC enabling switch is between the voltage sensors, and a controller programmed to command a closing of the AC enabling switch based on data from the voltage sensors such that the closing coincides with a zero crossing of voltage from a power source connected with the charge port.

### BRIEF DESCRIPTION OF THE DRAWINGS

FIG. 1 shows a schematic diagram of a vehicle charging arrangement.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Rather than redesigning components of an AC charge path of a present EV charging system to withstand high voltages of NACS operation, adding a switch that isolates the AC charge path from a separate charge path used when charging from an external power source may allow quicker adoption of NACS into present EV designs. Including the switch in present EV designs may present challenges. For example, components in the AC charge path may require pre-charging. For another example, a weld check of the switch may be required. Further, an improper weld may disable the specific EV's ability to accept a DC charge from an external power source. For yet another example, a power from the specific EV may require synchronization to power of a power source when connecting the specific EV to the power source to create an electrical connection between the traction battery and the power source. The electrical connection may allow the specific EV to supply power to the power source.

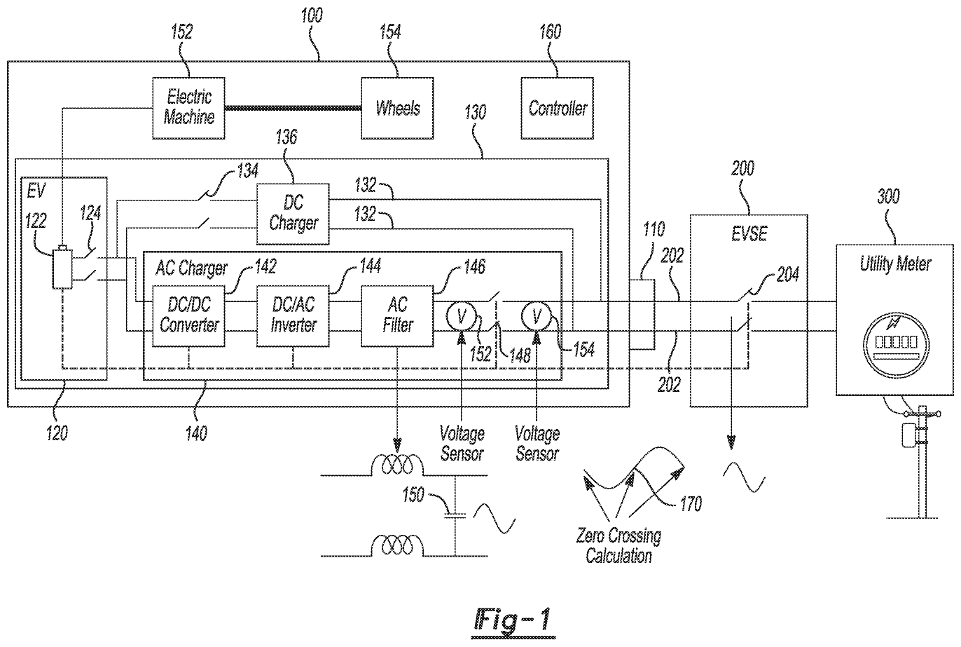

FIG. 1 shows a schematic diagram of an embodiment of a vehicle charge arrangement. A vehicle 100 may include a charge port 110. The vehicle 100 may also include a traction battery system 120. The traction battery system 120 may include a traction battery 122 and an isolating switch 124. Between the traction battery system 120 and the charging port 110, the vehicle 100 may include a charging system 130. The charging system 130 may include multiple charging paths from the charging port 110 to the traction battery system 120. One of the multiple charging paths of the charging system 130 may include a DC charge path 132. Another of the multiple charging paths of the charging system 130 may include an AC charge path 140. The DC charge path may include a DC/DC charger 136, and a DC enabling switch 134. The AC charge path 140 may include a DC/DC converter 142, a DC/AC inverter 144, an AC filter 146, and an AC enabling switch 148. The AC filter 146 may include a capacitor 150. At least one of the vehicle 100 or the charging system 130 may also include a controller 160.

The vehicle 100 may interface with an electric vehicle supply equipment 200. The electric vehicle supply equipment 200 may connect to the vehicle 100 at the charge port 110 with a charge cord 202. The electric vehicle supply equipment 200 may include a switch of the charge cord 204. The switch of the charge cord 204 may be located within the electric vehicle supply equipment 200, at a plug that interfaces with the charge port 110 of the vehicle 100, or anywhere between the plug and the electric vehicle supply equipment 200 such as on the charge cord 202. The electric vehicle supply equipment 200 may receive a power from a power source 300. The power source 300 may provide a power to the electric vehicle supply equipment 200, and the electric vehicle supply equipment 200 may charge the vehicle 100 using the power from the power source 300 when at least the switch 204 of the charge cord 202 is closed. Alternatively, the traction battery 122 may supply power to the power source 300 through the electric vehicle supply equipment 200 when at least the switch 204 of the charge cord 202 is closed. By these connections, the power source 300 may be considered associated with the electric vehicle supply equipment 200, the charge cord 202, and the switch of the charge cord 204. The power source 300 may include a grid or other energy resource.

The controller 160 of the vehicle 100 may be programmed to selectively operate any subset of the isolating switch 124, the DC enabling switch 134, the AC enabling switch 148, and the switch 204 of the charge cord 202 (together, “the switches 124, 134, 148, 204”). For many reasons, the controller 160 may be programmed to make the switches 124, 134, 148, 204 assume a certain configuration responsive to a physical connection from the electric vehicle supply equipment 200 to the charge port 110 of the vehicle 100 before a power from the electric vehicle supply equipment 200 is provided to the vehicle 100 through the charge cord 202 or before a power from the vehicle 100 is provided to the power source 300 through the electric vehicle supply equipment 200.

For example, the controller 160, after sensing that the charge cord 202 has been physically connected to the charge port 110, may close the isolating switch 124 and the DC enabling switch 134 and open the AC enabling switch 148 before requesting the electric vehicle supply equipment 200 close the switch 204 of the charge cord 202 to provide power to the vehicle 100. By the controller 160 making the switches 124, 134, 148, 204 assume the configuration described, the AC charge path 140 may be protected from a high-voltage power from the electric vehicle supply equipment 200 without inhibiting the DC charge path 132 from directing the high-voltage power to the traction battery system 120 to charge the traction battery 122. Because of this configuration, components of the AC charge path 140 may not need to be rated to withstand the high-voltage power that will pass to the traction battery 122 through the DC charge path 132.

For another example, the controller 160, after sensing that the charge cord 202 has been physically connected to the charge port 110, may close the isolating switch 124 and open the DC enabling switch 134 and the AC enabling switch 148. This configuration may be present momentarily before closing the DC enabling switch 134 to assume the configuration previously described or before closing the AC enabling switch 148 to electrically connect the traction battery 122 and the charge port 110 over the AC charge path 140. By leaving both the DC enabling switch 134 and AC enabling switch 148 momentarily open, power from the traction battery 122 may charge the capacitor 150 of the AC filter 146 of the AC charge path 140. The pre-charging power may come from another energy source in the vehicle 100, such as an auxiliary battery, etc. Because the capacitor 150 will have been pre-charged before the DC enabling switch 134 and the switch 204 of the charge cord 202 close to provide power to the vehicle 100, the capacitor 150 of the AC filter 148 may experience less inrush current, which may be beneficial to the capacitor 150 or reduce the likelihood of arcing at one of the switches 124, 134, 148, 204. This pre-charging process may occur after the charge port 110 is physically connected with the charge cord 202 but before an electrical connection between the traction battery 122 and the power source 300 is established by the controller 160 controlling at least one of the switches 124, 134, 148, 204.

The previous example may be considered a method step including after the charge port 110 is physically connected with the charge cord 202 and before an electrical connection between the traction battery 122 and a power source 300 associated with the charge cord 202 is established, pre-charging a capacitor 150 of an AC filter 146 of the AC charge path 140.

In some embodiments, a voltage sensor 152 may be located on the AC charge path 140 between the AC filter 146 and the AC enabling switch 148. In some embodiments, another voltage sensor 154 may be located between the AC enabling switch 148 and the charge port 110. That is, some embodiments may include only a single sensor, while other embodiments may include multiple sensors. The controller 160 may receive a signal from the voltage sensor 152 or the another voltage sensor 154 and may be programmed to respond in some way to that signal.

For example, at a certain time when the vehicle 100 is connected to the electric vehicle supply equipment 200, the controller 160 may receive a first signal corresponding to a voltage from the voltage sensor 152 while the isolating switch 124, the switch 204 of the charge cord 202, and the AC enabling switch 148 are closed. At a subsequent time, the controller 160 may open the AC enabling switch 148 then receive a second signal from the voltage sensor 152. The controller 160 may compare the first signal and the second signal. If the second signal shows a voltage drop caused by opening the AC enabling switch 148 occurred after the first signal, then the AC enabling switch 148 is working appropriately. If the second signal corresponds to about the same voltage as the first signal, then the AC enabling switch 148 may have malfunctioned or may include an improper weld. In the condition suggesting an appropriately working vehicle 100, the controller 160 may permit or command at least one of the vehicle 100 or the electric vehicle supply equipment 200 to initiate a DC charge mode using the DC charge path 132. Permitting or commanding may be directed to one or more of the switches 124, 134, 148, 204. In the condition suggesting a malfunction or improper weld of the AC enabling switch 148, the controller 160 may restrict or preclude at least one of the vehicle 100 or the electric vehicle supply equipment 200 from initiating a DC charge mode. Restricting or precluding may be directed to of one or more of the switches 124, 134, 148, 204. Restricting or precluding may include the controller 160 transmitting or storing record of the restriction or signaling an error condition to the user. This example may be implemented with only the voltage sensor 152.

The previous example may be considered a method that includes responsive to data from at least one the voltage sensors 152, 154 associated with the AC enabling switch 148 of the AC charge path 140 between the traction battery 122 and charge port 110 indicating a voltage across the AC enabling switch 148 has remained unchanged after commanding the AC enabling switch 148 to open while the isolating switch 124 between the traction battery 122 and AC charge path 140 and the switch 204 of the charge cord 202 connected with the charge port 110 remains closed, preclude DC charging of the traction battery 122 with power supplied via the charge cord 202; and responsive to the data indicating the voltage has reduced after the commanding, permit DC charging of the traction battery 122 via a DC charge path 132 that does not include the AC enabling switch 148.

For another example, at a certain time when the vehicle 100 is physically connected to the electric vehicle supply equipment 200, the controller 160 may receive a first signal corresponding to a voltage of the electric vehicle supply equipment 200 by the another voltage sensor 154. The controller 160 may pre-charge the capacitor 150 as previously described. The controller 160 may then direct the DC/AC inverter 144 of the AC charge path 140 to follow the voltage corresponding to the first signal using known techniques. The first signal may include an amplitude and phase angle information. After the controller 160 directs the DC/AC inverter 144 to follow the voltage corresponding to the first signal, the difference between a battery-side voltage (between the AC enabling switch 148 and the traction battery system 120) and a charger-side voltage (between the AC enabling switch 148 and the charge port 110) may be reduced below a threshold value. The controller 160 may then close the AC enabling switch 148. In some embodiments, the controller 160 may continue to receive signals from the voltage sensor 152 and the another voltage sensor 154 before closing the AC enabling switch 148 responsive to confirming from the signals that the battery-side and charger-side voltages are approximately equal.

The previous example may be considered a method step including commanding the DC/AC inverter 144 of the AC charge path 140 to follow a voltage from the power source 300 based on data from the at least one voltage sensor 152, 154.

For another example, at a certain time when the vehicle 100 is physically connected to the electric vehicle supply equipment 200, the controller 160 may receive a signal corresponding to a voltage of the electric vehicle supply equipment 200 by the another voltage sensor 154. The controller 160 may close the AC enabling switch 148 at a time coinciding with a zero crossing 170 of voltage from the electric vehicle supply equipment 200. Considering an AC signal, the zero crossing 170 occurs when a voltage with respect to a ground changes from positive to negative or negative to positive.

The previous example may be considered a method step including commanding a closing of the AC enabling switch 148 based on data from the at least one voltage sensor 152, 154 such that the closing coincides with the zero crossing 170 of voltage from the power source 300 associated with the charge cord 202.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Other topologies and variations are, of course, contemplated.

The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a charge port;
a traction battery system including a traction battery and an isolating switch;
a charging system including (i) a DC charge path, connected between the charge port and isolating switch, including a DC enabling switch and a DC/DC charger and (ii) an AC charge path, connected between the charge port and isolating switch, including a DC/DC converter, a DC/AC inverter, an AC filter including a capacitor, and an AC enabling switch connected between the charge port and AC filter; and
a controller programmed to, after the charge port is physically connected with a charge cord that is associated with a power source and before an electrical connection between the traction battery and power source is established, control at least some of the isolating, DC enabling, and AC enabling switches to permit pre-charging of the capacitor.

2. The vehicle of claim 1, wherein energy for the pre-charging is from the traction battery.

3. The vehicle of claim 1 further comprising a voltage sensor connected between the AC filter and AC enabling switch.

4. The vehicle of claim 3, wherein the controller is further programmed to, responsive to a voltage detected by the voltage sensor remaining same after commanding the AC enabling switch to open while the isolating switch and a switch of the charge cord are closed, preclude DC charging of the traction battery via the DC charge path.

5. The vehicle of claim 3 further comprising another voltage sensor connected between the charge port and AC enabling switch.

6. The vehicle of claim 5, wherein the controller is further programmed to command the DC/AC inverter to follow a voltage from the power source based on data from the another voltage sensor.

7. The vehicle of claim 5, wherein the controller is further programmed command a closing of the AC enabling switch based on data from the voltage sensors such that the closing coincides with a zero crossing of voltage from the power source.

8. The vehicle of claim 1, wherein the controller is further programmed to, after the pre-charging, control at least some of the isolating, DC enabling, and AC enabling switches to establish an electrical connection between the traction battery and power source.

9. A method comprising:
responsive to data from at least one voltage sensor associated with an AC enabling switch of an AC charge path between a traction battery and charge port indicating a voltage across the AC enabling switch has remained unchanged after commanding the AC enabling switch to open while an isolating switch between the traction battery and AC charge path and a switch of a charge cord connected with the charge port remain closed, preclude DC charging of the traction battery with power supplied via the charge cord; and
responsive to the data indicating the voltage has reduced after the commanding, permit DC charging of the traction battery via a DC charge path that does not include the AC enabling switch.

10. The method of claim 9 further comprising, after the charge port is physically connected with the charge cord and before an electrical connection between the traction battery and a power source associated with the charge cord is established, pre-charging a capacitor of an AC filter of the AC charge path.

11. The method of claim 10 further comprising commanding a DC/AC inverter of the AC charge path to follow a voltage from the power source based on the data.

12. The method of claim 9 further comprising commanding a closing of the AC enabling switch based on the data such that the closing coincides with a zero crossing of voltage from a power source associated with the charge cord.

13. An automotive charge system comprising:
a DC charge path, connected between a charge port and an isolating switch of a traction battery system, including a DC enabling switch and a DC/DC charger;
an AC charge path, connected between the charge port and isolating switch, including a DC/DC converter, a DC/AC inverter, an AC filter, an AC enabling switch connected between the AC filter and charge port, and a pair of voltage sensors connected such that the AC enabling switch is between the voltage sensors; and
a controller programmed to command a closing of the AC enabling switch based on data from the voltage sensors such that the closing coincides with a zero crossing of voltage from a power source connected with the charge port.

14. The automotive charge system of claim 13, wherein the controller is further programmed to, after the charge port is physically connected with a charge cord that is associated with the power source and before an electrical connection between a traction battery of the traction battery system and power source is established, control at least some of the isolating, DC enabling, and AC enabling switches to permit pre-charging of a capacitor of the AC filter.

15. The automotive charge system of claim 14, wherein energy for the pre-charging is from the traction battery.

16. The automotive charge system of claim 13, wherein the controller is further programmed to, responsive to the data indicating a voltage across the AC enabling switch remains same after commanding the AC enabling switch to open while the isolating switch and a switch of a charge cord connected with the charge port are closed, preclude DC charging of the traction battery via the DC charge path.

17. The automotive charge system of claim 13, wherein the controller is further programmed to command the DC/AC inverter to follow a voltage from the power source based on the data.
